(19) United States
(12) Patent Application Publication
(10) Pub. No.: US 2009/0117972 A1
(43) Pub. Date: May 7, 2009

(54) Systems and/or methods for distributing bonus rewards based on accumulated gaming device wins

(75) Inventor: Joseph F. Cava, Village of Lakewood, IL (US)

Correspondence Address: NIXON & VANDERHYE, PC, 901 NORTH GLEBE ROAD, 11TH FLOOR, ARLINGTON, VA, 22203, US

(73) Assignee: PALTRONICS, INC., Crystal Lake, IL (US)

(21) Appl. No.: 11/979,302

(22) Filed: Nov. 1, 2007

(51) Int. Cl. A63F 13/00

(52) U.S. Cl. 463/20; 463/27

(57) ABSTRACT

Certain exemplary embodiments described herein relate to gaming machines and/or table games being configured to provide random rewards in dependence on accumulated gaming device wins. According to certain exemplary embodiments, in connection with a gaming network comprising a plurality of gaming devices, a method of providing a random reward to a patron using a gaming device connected to said gaming network is provided. A random number for win determination is generated. A coin-out counter accessible by the gaming device being used by the patron is initialized. A random win amount for the patron is generated. It detected whether a coin-out event has occurred on the gaming device. When a coin-out event is detected, the coin-out counter is incremented. When the coin-out counter is greater than or equal to the random number for win determination, a random reward event is triggered, which results in a qualified patron on the link being awarded the random reward amount displayed.

### TECHNICAL FIELD

The exemplary embodiments described herein relate to gaming machines and/or table games used within a gaming environment and, more particularly, to gaming machines and/or table games being configured to provide bonus rewards in dependence on accumulated gaming device wins. In certain exemplary embodiments, the accumulated gaming device wins are based on coin-out events, rather than on coin-in events.

### BACKGROUND AND SUMMARY

For years, gaming machines (e.g., of the type typically found in casinos, on riverboats, and/or in other gambling establishments) have provided patrons or players with enjoyment and proprietors with revenue. Broadly speaking, they have evolved from simple, classic slot machines featuring mechanical arms that a player would pull, to more complicated video-based versions of slots, poker, and other games, with one or more buttons sometimes replacing the functions served by the mechanical arm. Further changes have included, for example, incorporating multiple displays to support advertising and/or sometimes even additional games.

As the desire for more engaging entertainment has increased yet further, some providers began configuring their gaming machines for use in a networked environment. This arrangement, in turn, has enabled some game providers to offer bonus rewards for players using gaming machines. For example, one type of bonus rewards available to players is random rewards. Generally speaking, random rewards enable players who initiate a wager to become eligible to win one or more randomly selected monetary percentages as a function of a random number of an entire fixed or progressive prize pool, with or without regard to game outcome. Techniques associated with providing random rewards are disclosed, for example, in U.S. Pat. No. 6,626,758, the entire contents of which are hereby incorporated herein by reference. The random rewards trigger event (which is triggered when the coin-out threshold is met or exceeded) causes a controller and/or server to find a qualified patron (e.g., someone who is playing on that particular link) to win a random rewards amount displayed on the respective gaming machine. It will be appreciated that it could be the gaming machine that triggered the event, or some other machine on the link that has a qualified player.

In greater detail, random rewards is a mystery-like variant that behaves much like a standard “mystery” behaves, except that random rewards generates additional excitement by randomly rewarding patrons with smaller, more frequent bonuses while the random rewards top award grows. With each new game played on an eligible machine, the patron typically is shown the random rewards amount they could win if their gaming machine is randomly selected to pay out its random rewards amount. Any machine on a random rewards link may randomly initiate a random rewards trigger event which results in one of the eligible machines on the random rewards link being randomly selected to reward its random rewards amount to the machine. The random rewards trigger events on a random rewards link are counted and, once this count reaches a randomly selected threshold, an eligible machine on the random rewards link is randomly selected to receive the random rewards top award to the machine. Conventionally, the trigger events used for random rewards have been “coin-in” events, which occur whenever a patrons makes a wager.

Random rewards may be funded by, for example, promotional dollars or patron contribution. When funded with promotional dollars, referred to as “carded play,” random rewards will be activated on a machine when the patron inserts their loyalty card into the machine. Loyalty cards may be grouped by card grade, such as, for example, Silver, Gold, or Platinum. Each card grade may be linked to play for a different range of random rewards amounts and for a different random rewards top award. For example, loyalty cards categorized as Gold may play for random rewards amounts between $10 and $20, with a random rewards top award starting at $1,000, while loyalty cards categorized as Platinum may play for random rewards amounts between $30 and $50, with a top award starting at $20,000. When funded with patron contribution, referred to as “uncarded play,” random rewards may link one, some, or all of the machines on a casino floor to a random rewards link. Any patron contributing to the random rewards link may be eligible to be randomly selected to win either the random rewards amount displayed on their machine or the random rewards top award, or both.

Conventionally, random rewards is implemented on a casino floor using machine interface cards (MICs) and jackpot controllers. A MIC is connected to each gaming device that may be linked to one or more random rewards links. Each MIC is connected to a jackpot controller. These two devices generally handle the random rewards processing.

The MIC uses its random number generator (RNG) to randomly generate the random rewards amount to be displayed for each game and for determining the threshold value at which it triggers random rewards trigger events. The MIC is also responsible for sending the random rewards amount generated for each game and any random rewards winner notifications out of its display port, and for transferring random rewards winner amounts to the machine, should that machine be selected to reward its random rewards amount for the game played. Any display device that supports the random rewards messaging protocol can be used to display the random rewards amount and random rewards winner notifications. Most displays, in-machine meters, overhead LED signs, LED tablets, and OSK Media Signs commercially available from Paltronics, support the random rewards messaging protocol. However, any vendor may also implement this protocol to support the display of random rewards amounts and random rewards winner notifications.

The jackpot controller typically uses its RNG to randomly select gaming machines from the pool of eligible gaming machines to receive their random rewards amount as the result of receiving a random rewards trigger event. The jackpot controller generally is also responsible for keeping a count of each random rewards trigger event for each random rewards link, using its RNG to determine the count threshold value, and for randomly selecting a machine to receive the random rewards top award once the random rewards trigger event count for a particular random rewards link has crossed its randomly selected count threshold. Any display device that supports the random rewards messaging protocol may be used to display the current random rewards top award amount and random rewards winner notifications. For “uncarded play,” the MICs and jackpot controllers and any combination of display devices that support the random rewards messaging protocol typically are sufficient to generate the excitement intended from random rewards. However, for “carded play,” integration with a loyalty card system may be used to distinguish between “uncarded play” and “carded play,” as well as different card grade groups.

As alluded to above, conventional implementations of random rewards use an RNG for determinations of win as well as determinations of win amount. In the process of determining whether there is a win, the RNG generates a number. Each time a coin-in event occurs (which happens each time a patron plays a game triggering the coin-in event), a counter based on the number of coin-ins is incremented and stored. When the counter equals or exceeds the number generated by the RNG, a random rewards payout event is triggered.

Unfortunately, it is not always possible to use this conventional technique for the provision of bonus rewards (such as, for example, random rewards). For example, certain gaming commissions do not allow a randomizer to be used for the determination of win in connection with the coin-in event. As one example, it is noted that the Nevada Gaming Commission requires a vendor to be licensed to perform any operations based on coin-in for any sort of payout. This means that prospective vendors would have to qualify for, and eventually obtain, a license, to practice, for example, conventional bonus rewards techniques (including, for example, conventional random rewards techniques).

Vendors have almost always sought to base their determination of wins on game play directly, which requires resort to the coin-in event. Because of this strong desire, the overwhelming tendency for vendors is to simply “get licensed” by the relevant gaming commission. Consequently, almost no efforts have been made to overcome the challenges posed by these illustrative restrictive rules and licensing requirements.

There has been one attempt to base the determination of wins on something other than a coin-in event. In particular, the attempted solution incremented its counter based on a particular payline in a paytable. The attempt essentially sought to create a random progressive game based on a particular payline. Unfortunately, this approach becomes extremely complicated when multiple games with many kinds of paylines are implemented. For example, in such a connection, after a particular payline was chosen (e.g., a full-house in a 5 card stud poker game), it would become necessary to determine corresponding paylines across all gaming machines, or at least all gaming machines to be configured to receive bonus rewards. Despite the technical complexities, such an idea was proposed to the Nevada Gaming Commission in connection with the World Series of Poker. The Nevada Gaming Commission rejected this idea because it did not like the complexities of the technique or the base idea of using a particular payline as a trigger.

Thus, it will be appreciated that there is a need in the art to overcome one or more of these and/or other complications, and/or to implement an alternative technique for providing bonus rewards.

In certain exemplary embodiments, in connection with a gaming network comprising a plurality of gaming devices, a method of providing a bonus reward to a patron using a gaming device connected to said gaming network is provided. A random number for win determination is generated. A coin-out counter accessible by the gaming device being used by the patron is initialized. A random win amount for the patron is generated. It detected whether a coin-out event has occurred on the gaming device. When a coin-out event is detected, the coin-out counter is incremented. When the coin-out counter is greater than or equal to the random number for win determination, the random win amount is awarded to the patron.

In certain exemplary embodiments, a method of providing a bonus reward to a patron using a gaming device is provided. A random number for win determination is generated. A coin-out counter accessible by the gaming device being used by the patron is initialized. For each wager made using the gaming device, a random win amount is generated for the patron and the random win amount is displayed to the patron. It is detected whether a coin-out event has occurred on the gaming device. When a coin-out event is detected, the coin-out counter is incremented. When the coin-out counter is greater than or equal to the random number for win determination, the random win amount is awarded to the patron, a new random number for win determination is generated, and the coin-out counter is reinitialized.

In certain other exemplary embodiments, a gaming device configured to provide a bonus reward to a qualified patron on a bonus rewards link is provided. A coin-out monitor is configured to detect a coin-out event of the gaming device and to increment a coin-out counter based on the detected coin-out event. A processor is configured to award a random win amount generated by a random number generator to the patron when the coin-out counter is greater than or equal to a random number for win determination generated by the random number generator.

In certain other exemplary embodiments, a gaming device configured to provide a bonus reward to a patron is provided. A random number generator is configured to generate a random win amount and a random number for win determination. A coin-out monitor is configured to detect a coin-out event of the gaming device. A coin-out counter is configured to be incremented based on a detected coin-out event. A processor is configured to award the random win amount generated by the random number generator to the patron when the coin-out counter is greater than or equal to the random number for win determination generated by the random number generator.

Although certain exemplary embodiments have been described in relation to random rewards, it will be appreciated that the present invention is not so limited. For example, certain exemplary embodiments described herein may be used to provide bonus rewards according to any bonusing scheme (including, for example, mystery), simply by using coin-out events as triggers rather than coin-in events.

These exemplary features, aspects, and advantages may be combined in various combinations and ways to achieve yet further embodiments.

### BRIEF DESCRIPTION OF THE DRAWINGS

These and other features, aspects, and advantages will be better and more completely understood by reference to the following detailed description of exemplary illustrative embodiments in conjunction with the drawings, of which:

FIG. 1 is a current gaming machine for use with a current gaming network of the type typically used in casinos;

FIG. 2 shows a plurality of gaming machines and associated peripherals being located on a casino floor and being connected in a networked environment;

FIG. 3 is an improved gaming machine in accordance with an exemplary embodiment;

FIG. 4 shows a plurality of improved gaming machines and associated peripherals located on a casino floor and being connected in a network environment in accordance with an exemplary embodiment;

FIG. 5 is an illustrative schematic view of an improved MIC in accordance with an exemplary embodiment;

FIG. 6 is an illustrative flowchart showing a process for providing bonus rewards in accordance with an exemplary embodiment;

FIG. 7 shows a plurality of improved table games being located on a casino floor and being connected in an improved networked environment in accordance with an exemplary embodiment;

FIG. 8 is a partial schematic view of a casino floor including connections to improved gaming machines and improved table games in accordance with an exemplary embodiment; and

FIG. 9 is an illustrative multi-property layout of improved gaming machines and improved table games in accordance with an exemplary embodiment.

### DETAILED DESCRIPTION

The exemplary embodiments described herein relate to gaming machines, table games, and/or other such gaming devices to be used within a gaming environment that are configured to provide bonus rewards in dependence on accumulated gaming device wins. In certain exemplary embodiments, the accumulated gaming device wins are based on coin-out events, rather than on coin-in events.

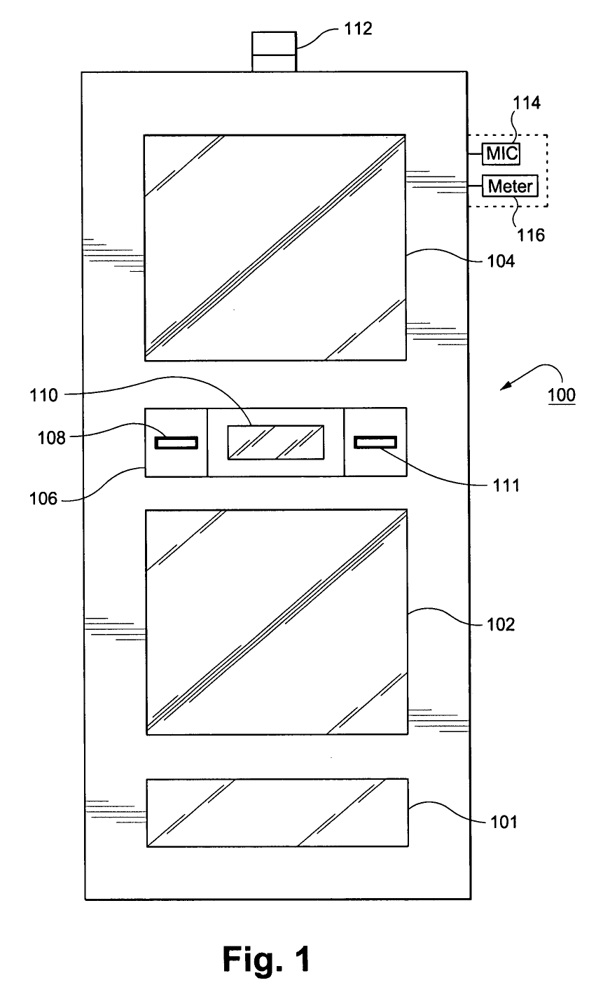

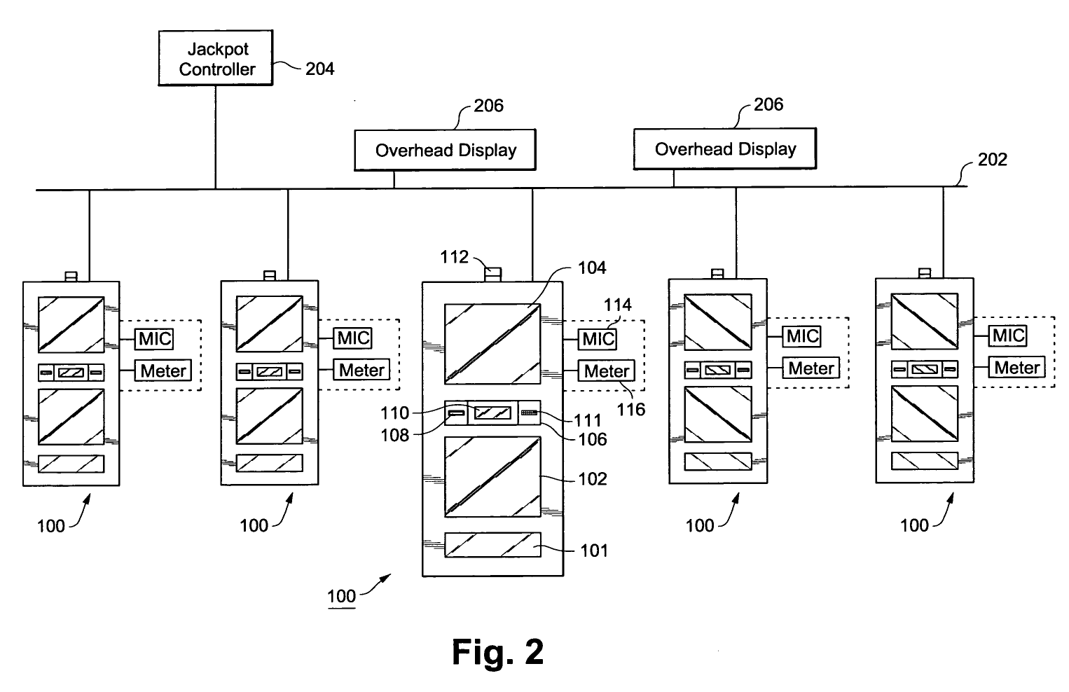

Referring now more particularly to the drawings, FIG. 1 is a current gaming machine 100 for use with a current gaming network of the type typically used in casinos, and FIG. 2 shows a plurality of gaming machines 100 and associated peripherals being located on a casino floor and being connected in a networked environment. For aesthetic purposes, belly glass 101 often is provided on gaming machines. Each gaming machine includes a first display area 102, generally referred to as a game screen. The game screen 102 traditionally has been where most of the “action” happens. For example, the game screen 102 may simulate the rolling of the reels on a slot machine and thus indicate whether the player has won any money. A second display area 104, generally referred to as a top box, also is provided. The top box 104 may display additional information for the player, such as, for example, advertising, generally entertaining animations, bonus game opportunities, etc.

The game screen 102 and/or the top box 104 may be touch screen monitors and thus accept input directly. Such input may pertain to, for example, the number of credits to bet, the way in which a bet may be made, whether to initiate a bet, whether to cash out, etc. In other cases, a separate control panel (not shown) may be provided to enable the same and/or similar functionality.

The gaming machine 100 also is provided with a player tracking module (PTM) area 106. The PTM area 106 includes a payment acceptor (e.g., a card reader, a coin and/or dollar acceptor, etc.) 108 to accept payment (e.g., cash, an encoded card storing credits or linked to a database with credit information, or the like) from the player. A small display screen (or PTM) 110 is located in the PTM area 106 and enables the player to access certain other more individualized services. For example, the PTM 110 may enable the player to call an attendant to order drinks. In such a case, the PTM 110 may cause the candle 112 (e.g., one or more differently colored lights) of the gaming machine 100 to become lit to signal to casino personnel that the player is requesting some form of service. The PTM 110 typically is an LCD screen and typically is operated using control panel 111.

The PTM 110 may have a computer-readable storage medium (not shown) associated therewith. The computer-readable storage medium typically is a small flash drive, hard drive, or other suitable memory location. Information may be distributed to the PTM 110 and at least temporarily stored on the computer-readable storage medium. In this way, it is possible to provide some media offerings to the gaming machine 100 for display by the PTM 110. More particularly, the computer-readable storage medium is used as a buffer for the media offerings that ultimately may be displayed by the PTM 110.

The game screen 102 and the top box 104, and the respective associated circuitry, typically are provided by a single company. The PTM 110 often is provided by another vendor. Sometimes, the PTM 110 will be integrated into the gaming machine 100. However, it is often the case that the gaming machine 100 will be retrofitted with a PTM 110. As such, the hardware and software systems for the game screen 102 and the top box 104 typically are independent of the hardware and software systems for the PTM 110.

This separation often makes integration between the various components cumbersome. Thus, to accommodate these features related to the PTM area 106, gaming machines are equipped with special purpose hardware to facilitate this and/or similar arrangements. It will be appreciated that the player management tracking and information management features provided typically exist outside of the normal base game(s) environment, which deal directly with game play rather than ancillary services, patron interaction, feedback, and the like.

It will be appreciated that although the gaming machines 100 shown in FIG. 2 all appear the same, the present invention is not so limited. A wide variety of gaming machines may be provided, as may table games, roulette tables, etc. Variations to each may include changes in terms of configuration, style, type, functionality, payouts, etc.

In many cases, an RS-485 connection is utilized. The connection often is to a machine interface card (or MIC) 114 located within each gaming machine. In essence, the MIC 114 translates between the gaming machine 100 and the network 202, making all such gaming machines appear to be the same from the perspective of the network 202.

As alluded to above, a plurality of gaming machines 100 may be located on a casino floor and be connected in a networked environment, e.g., via network 202. To this end, a plurality of central systems (not shown) are connected to the networked environment to collect and/or distribute data, as necessary. Each gaming machine 100 may be connected to one or more of the central systems via a network link. Such network links typically are proprietary and are based on unicast, broadcast, multi-drop, and/or other suitable network protocols. Although proprietary protocols often are implemented, the typical effect is that data is transmitted to/from the central systems over a broadcast channel or to one or more targeted groups (e.g., a bank of gaming machines in a row, in a particular area of the gaming floor, etc.) over connections.

There are at least three separate systems or modules comprising the central systems. A first system, management and accounting subsystem, provides management and accounting functions, also sometimes called auditing functions. Typically, these functions gather and/or report coin-in and coin-out operations, door openings (e.g., when a gaming machine is serviced), service cycles in general, ticket replacements, and the like. This activity generally is linked to the game being played on the gaming machine and/or the gaming machine itself.

A second system, player tracking subsystem, provides player tracking functions. More specifically, such systems link players on the gaming floor to particular activities undertaken by the players on the gaming floor. The information typically tracked for each player includes, for example, the session of game play (e.g., date, time, location, type of machine, type of game, etc.) as well as the individual's profile (e.g., name, address, and/or other identifying information such as hair color). The player tracking subsystem also may interface with the PTM 110 of a particular gaming machine 100.

A third system, bonusing subsystem, provides enhancements which may or may not be related to the base game. Such enhancements may relate to bonusing, progressive games, mystery, secondary games, random rewards (e.g., as disclosed in U.S. Pat. No. 6,626,758), etc. This system typically interfaces with the PTM 110.

Other systems may be included in the central systems. For example, other modules may be provided for detecting cash-in, cash-out, and/or data mining purposes. Data mining may be used, for example, in connection with marketing activities, accounting and/or auditing activities, etc.

Reports may be generated by the central systems, for example, to report on earnings, operational efficiencies, repairs, etc. Such reports also may be the result of the above-described data mining operations.

An in-machine meter 116 may be provided to the gaming machines 100 to cooperate with the central systems (e.g., to provide information regarding game plays, amounts of wagers, payoffs, etc.).

In addition to the gaming machines 100 existing in the network, one or more overhead displays 206 may be connected to the network 118. The overhead displays 206 may receive data from the central systems indicating, for example, the jackpot amount(s) (e.g., current, daily, monthly, etc.), payouts (e.g., current, daily, monthly, etc.), winners, etc.

A jackpot controller 204 also is connected to the network 202. A single jackpot controller may be assigned to a bank of gaming machines 100. Typically, a jackpot controller is configured to accept a single bank of up to 124 gaming machines. The jackpot controller 204 may be responsible for calculating jackpots, changing the turnover on every hit and/or on every play, returning the winning amounts, etc. The jackpot controller 204 may be a progressive jackpot controller or it may be a non-progressive jackpot controller. Alternatively, multiple jackpot controllers 204 may be used within a single bank or among multiple banks. For example, separate jackpot controllers 204 may be respectively responsible for progressive and non-progressive jackpots. In still other alternate arrangements, multiple instances running on one or more jackpot controllers 204 may be dedicated to various banks of gaming machines, progressive and/or non-progressive jackpots, etc. In still other alternative arrangements, jackpot controllers may be installed in each machine individually, so that the need for a network connection is reduced (e.g., sometimes even eliminated) and so that base games can be played on gaming machines in a more “stand-alone” arrangement.

In accordance with certain exemplary embodiments, when a bonus rewards type bonus game is provided, the accumulated gaming device wins are based on coin-out events, rather than on coin-in events as is conventionally done. The coin-out event is triggered whenever the patron wins an amount. Over time, a gaming machine is said to payout 97% of the funds it takes in. Thus, it has been discovered by the inventor of the instant invention that the coin-out event may be thought of as a function of the coin-in event over time, making the coin-out event somewhat akin to the equivalent of coin-in, only in “reverse.” Although the coin-out event is a fairly poor approximation of the coin-in event in the short-term, it is an excellent approximation over a fairly long period of time. Thus, over time, using the coin-out event rather than the coin-in event enables certain exemplary embodiments to obtain coin-in-like results substantially without relying on coin-in based processing. As such, certain exemplary embodiments provide techniques that allow substantially the same functionality (e.g., bonus rewards functionality) while also complying with a gaming commission's prohibition on certain coin-in related functionality (e.g., gaming commission rules prohibiting the use of a randomizer in connection with the coin-in event for the determination of win, and/or rules requiring vendors to be licensed to perform any operations based on coin-in for any sort of payout).

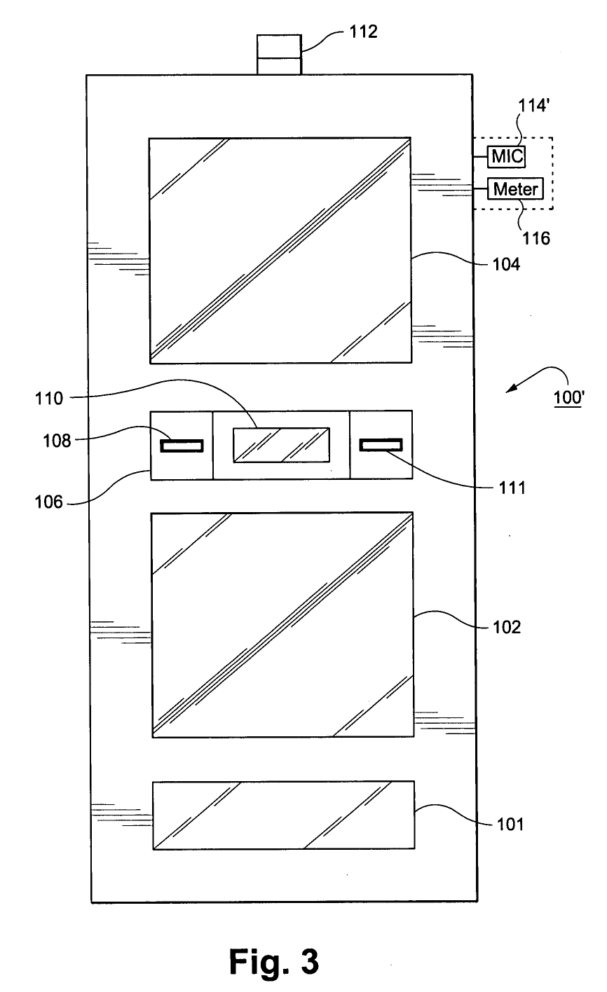

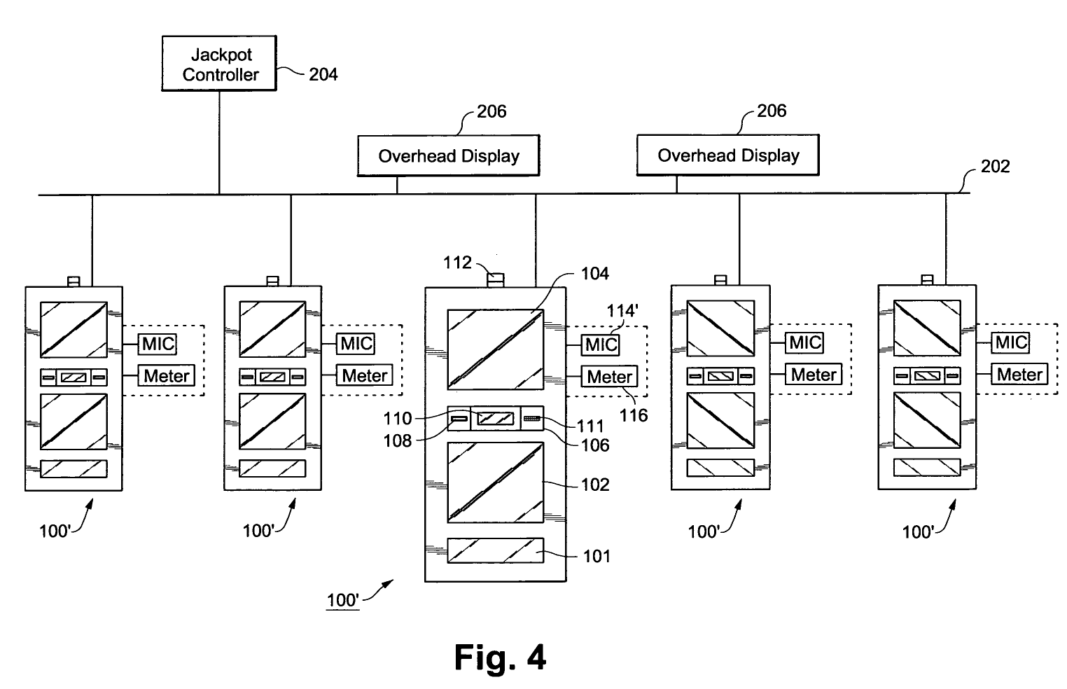

Such functionality may be enabled, for example, by the gaming machines shown in FIGS. 3 and 4. More particularly, FIG. 3 is an improved gaming machine in accordance with an exemplary embodiment, and FIG. 4 shows a plurality of improved gaming machines and associated peripherals located on a casino floor and being connected in a network environment in accordance with an exemplary embodiment.

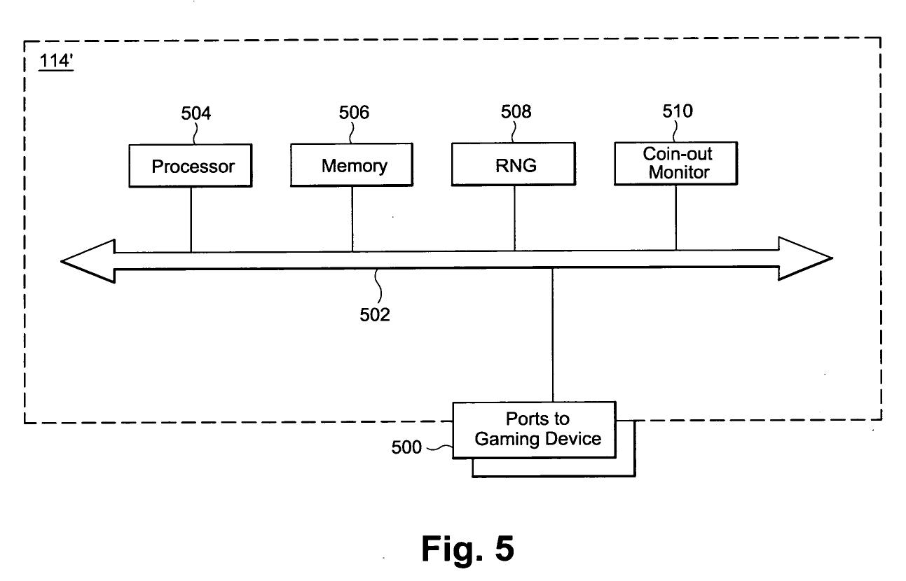

FIGS. 3 and 4 are similar to FIGS. 1 and 2. However, the gaming machines 100′ of FIGS. 3 and 4 each include an improved MIC 114′. An illustrative schematic view of an improved MIC 114′ in accordance with an exemplary embodiment is shown in FIG. 5. The improved MIC 114′ is connected to the gaming machine via one of a plurality of ports 500. Typically, a gaming device will include at least two ports (e.g., serial ports). A first port typically connects to an accounting system, while the MIC 114′ may be connected to a second port. The MIC 114′ may include a central bus 502, to which a processor 504 capable of executing instructions is connected. A memory 506 also is connected to the bus 502. The memory 506 may be, for example, a hard drive, a flash drive, or any suitable form of computer readable storage medium capable of at least temporarily storing data. A random number generator 508 capable of generating random numbers also connected to the bus 502. The MIC 114′ may be implemented as any suitable combination of programmed logic circuitry, including, for example, hardware, software, firmware, combinations thereof, and/or the like.

Each time the player wagers using the improved gaming machine 100′, the MIC 114′ detects this event through a port 500 (e.g., a secondary SAS port). At this point, the processor 504 instructs the RNG 508 to generate a random number corresponding to a random win amount (e.g., a bonus reward). This number is displayed on a display of the gaming machine 100′, such as, for example, the main display 102, the top box 104, or the PTM 110.

If the player hits any paytable win, the MIC 114′ also detects this event (e.g., via the coin-out monitor 510) and adds the payout amount to a coin-out counter (e.g., stored in memory 506). The coin-out event is triggered whenever the patron wins an amount. The MIC 114′ then compares the coin-out counter to a previously chosen random number (e.g., generated by the RNG 508 of the MIC 114′). When the coin-out counter value meets or exceeds the random number of coins-out, the MIC 114′ triggers a bonus rewards event which results in the displayed bonus reward being awarded to a randomly chosen qualified gaming machine 100′ via bonusing commands on the appropriate port. Also, after a bonus rewards win, the MIC 114′ may pick a new random number of coins-out before the next game play and store this number in memory 506 in place of the previous number.

In certain exemplary embodiments, the ranges (e.g., maximum and minimum) for the random win amount and the random number of hits are configurable parameters. Thus, an authorized user may set such parameters. The win amount typically is set by an authorized user as a function of machines participating and the amount to give out. By way of example and without limitation, for a small operation for low level players, about $1-5 may be given out on about every $200 taken in by a bank of suitably configured gaming machines. Also, in certain exemplary embodiments, payouts may be a progressive-based giveaway. It will be appreciated that the ranges, target earnings and/or giveaways, etc., may be selected based on any number of criteria, e.g., by an authorized user, and that the illustrative values provided and criteria provided herein are given by way of example and without limitation.

Although the MIC 114′ is shown as having an RNG 508 configured to generate both a random win amount and a random number of coins-out, it will be appreciated that the present invention is not limited to this configuration. For example, in certain exemplary embodiments, the responsibility for generating such random numbers may be shifted to or shared among any number of randomizers. Such randomizers may be located anywhere that is accessible by the relevant gaming machine 100′ including, for example, at a jackpot controller, in its own dedicated central system, or anywhere on the gaming network. Similarly, the random numbers generated may be stored in a computer readable storage medium located in any suitable location, e.g., on the gaming network.

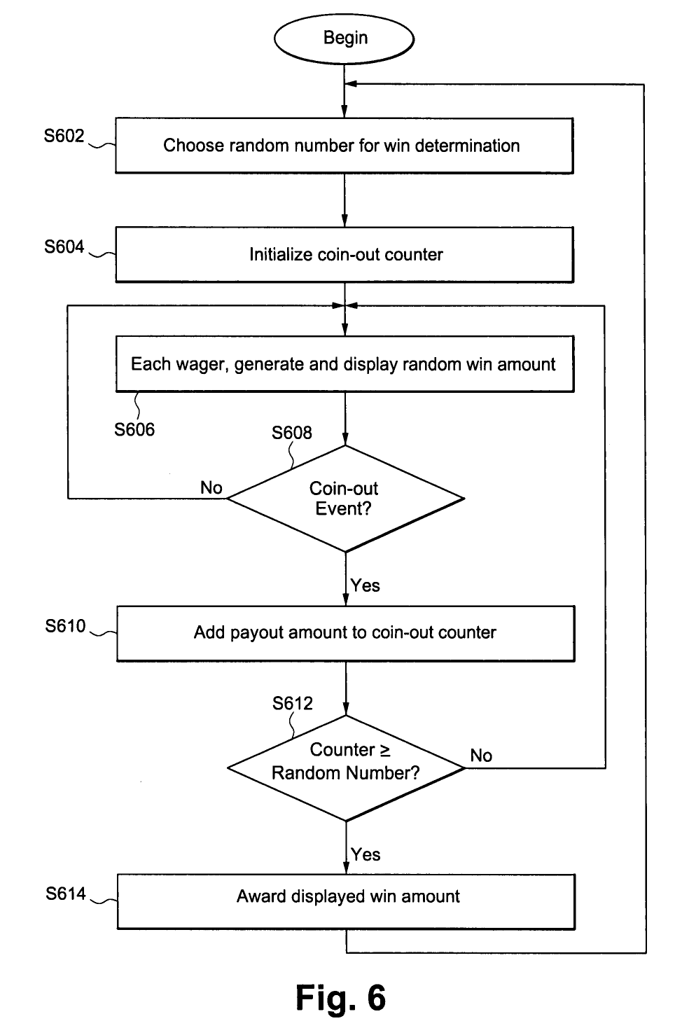

FIG. 6 is an illustrative flowchart showing a process for providing bonus rewards in accordance with an exemplary embodiment. In step S602, a random number for win determination is chosen. A coin-out counter is initialized in step S604. Each wager, a random win amount is generated in step S606. Optionally, it also may be displayed to the player. In step S608, it is determined whether a coin-out event has occurred (e.g., whether there has been a paytable win on the gaming machine). In certain exemplary embodiments, if there is no coin-out event, then gaming continues as normal, and the process returns to step S606. In certain other exemplary embodiments, the process may instead choose a new random number for win determination and then return to step S606.

If, however, it is determined that there was a coin-out event, the coin-out counter is incremented in step S608. It will be appreciated that the coin-out counter may be incremented sequentially (e.g., by “ones” each time a coin-out event occurs), by the amount of the win, or in some other way. In step S612, it is determined whether the coin-out counter is greater than or equal to the random number generated above. If it does not, gaming continues as normal, and the process returns to step S606. In certain other exemplary embodiments, the process may instead maintain the same random win amount rather than generating a new one in step S606.

If, however, it is determined that the coin-out counter is greater than or equal to the random number generated above, the win amount is awarded in step S614. Optionally, in a step or in multiple steps not shown, additional indications of a bonus reward being distributed may be triggered. For example, one or more overhead displays may indicate the same, messages may be distributed to gaming devices, etc. Once the award of step S614 is completed, the process returns to step S602, wherein a new random number for win determination is generated and the process repeats. Similarly, in one or more optional steps not shown, the amount of funds being accumulated for a bonus reward and/or a bonus reward top amount being accumulated prior to a win also may be similarly displayed.

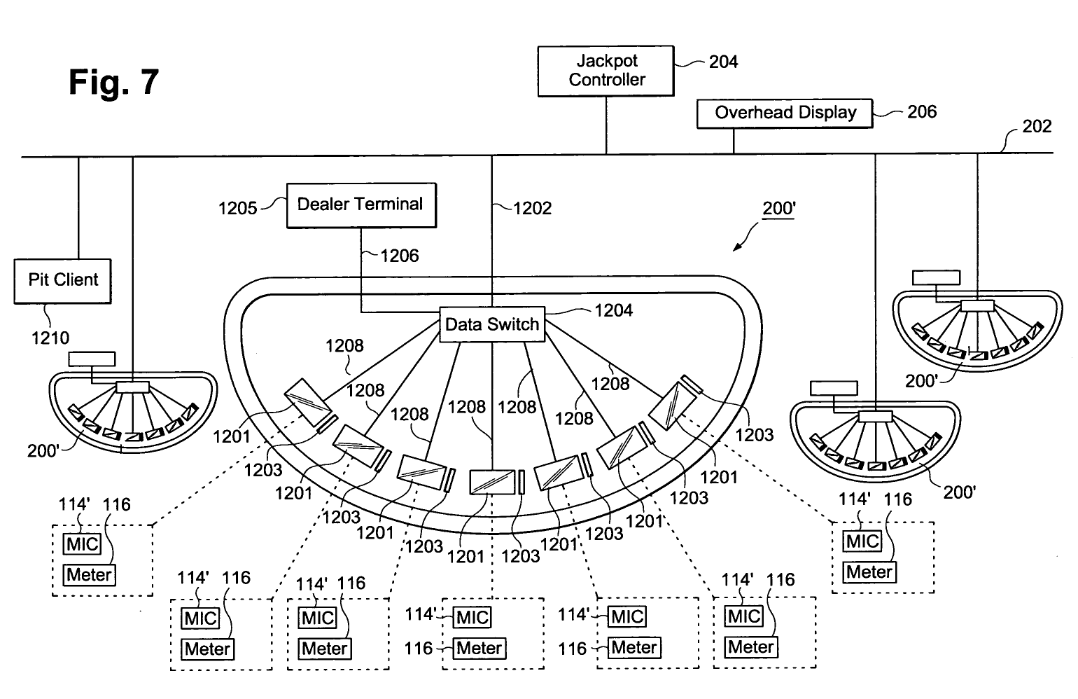

It will be appreciated that similar techniques may be applied to table games. For example, FIG. 7 shows a plurality of improved table games 200′ being located on a casino floor and being connected in an improved networked environment in accordance with an exemplary embodiment. In FIG. 7, each improved table 200′ has a number of player positions. More particularly, seven player positions are shown, as this is the customary number of player positions at blackjack tables, for example. Of course, the invention is not limited to a particular number of player positions or to any particular table game.

Each player position includes a display 1201 and a payment acceptor and/or card reader 1203 (similar to the payment acceptor 108 described above). The player may have the ability to place side wagers and/or a main wager via the interface offered by the display 1201. Each player position also includes an improved MIC 114′, an in-table meter 116, similar to the components described above with relation to FIG. 3. These components are not shown at every table 200′ for the sake of readability of FIG. 7.

There also is a dealer terminal 1205 provided to each table. The dealer terminal 1205 includes a player representation and a keypad. The dealer may use the dealer terminal to make player credits/debits, retrieve the status of any player (e.g., amount of credits, whether the player is a preferred patron, etc.), and the like. For example, the dealer may designate a player in the player representation and indicate, via the keypad, whether to credit/debit the player's account, what the player's hand included, etc.

Data may be logged (e.g., to one or more databases of the central servers) during and/or after the play of each player.

A connection 1202 is provided to each table 200′ from the network 202 so as to connect each respective table 200′ to, for example, the central systems (not shown) and the jackpot controller 204 via a data switch 1204. Via connection 1206, the data switch connects the dealer terminal 1205 to the network 202. Similarly, via connection 1208, the data switch 1204 connects each of the player positions to the network 202.

In certain exemplary embodiments, each table 200′ will have its own associated data switch 1204. In such exemplary instances, the network 202 may be kept more “flat” and thus network latencies may be decreased. However, in certain other exemplary embodiments, the player positions and the dealer terminal may be directly addressable across the network 202.

A pit client 1210 also sits on the network 202. A pit, or area of table games within a casino, typically comprises 2-12 such tables. There may be multiple pits within a single casino. One or two pit bosses typically are assigned to a pit. In place of or in addition to pit bosses, the pit client 1210, via its connection to the central systems 202 and to the tables individually, may provide substantially real-time player ratings. These player ratings may be actual, rather than merely estimated, ratings. In addition to actual and substantially real-time ratings, actual substantially real-time player and table accountings may be gathered. Moreover, promotional and/or contributional bonusing may be provided based on an individual's identity, an individual player's rating, on a particular table's action, on the action within a pit, on a property-wide basis, according to a multi-property basis, etc.

Although a single jackpot controller 204 is shown on the network, the present invention is not so limited. For example, a jackpot controller 204 or an instance of a jackpot controller 204 may be provided to each pit.

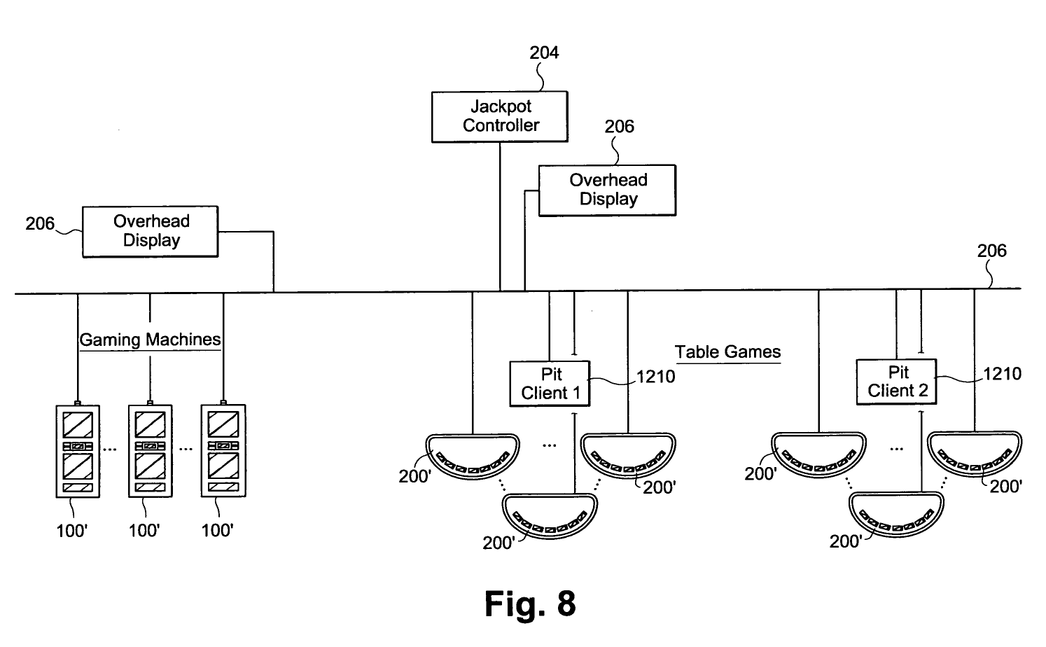

FIG. 8 is a partial schematic view of a casino floor including connections to improved gaming machines 100′ and improved table games 200′ in accordance with an exemplary embodiment. The improved gaming machines 100′ and improved table games 200′ are, of course, connected to the network 202. The table games 200′ may be divided into one or more pits, as is conventional.

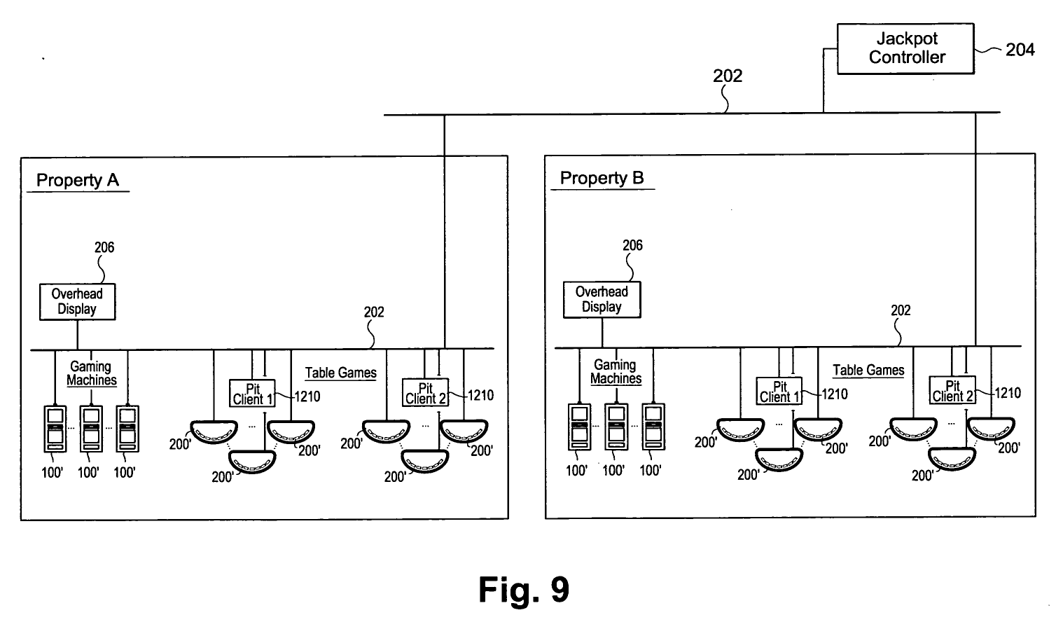

FIG. 9 is an illustrative multi-property layout of improved gaming machines and improved table games in accordance with an exemplary embodiment. In certain exemplary embodiments, some or all of the above-described features may be provided across multiple properties. Thus, for example, random rewards scenarios and/or pools may be defined across multiple properties. Thus, one or more jackpot controllers 204 may be provided for multiple properties to share.

It will be appreciated that in certain exemplary embodiments, bonus rewards may be awarded within smaller areas in a single casino. The smaller areas may include, for example, one or more pits, one or more banks of gaming machines, and/or any combination thereof, etc.

Although certain exemplary embodiments have been described as relating to gaming machines and table games in casinos, it will be appreciated that the present invention is not so limited. For example, the exemplary embodiments described herein may be used in connection with casinos, riverboats, restaurants, hotels, etc. Also, it will be appreciated that similar to the techniques described in relation to gaming machines and/or table games may be applied to other gaming devices in certain exemplary embodiments including, for example, roulette tables, craps tables, etc.

Instead of, or in addition to, indications being provided directly on the main screen, top box, and/or PTM of gaming machines, directly on display areas of table games, and/or other information being displayed on overheads, kiosks, and/or the like, it will be appreciated that such information may be displayed and/or redisplayed on one or more floatable layers provided to any gaming device and/or display in the network gaming environment. Floatable layers are described in for example, co-pending and commonly-assigned application Ser. Nos. 11/889,970 and 11/889,971, the entire content of each of which are hereby incorporated herein by reference.

It also will be appreciated that the coin-out techniques described herein may be applied to other bonus games and/or base games apart from, or in addition to, the particular bonus rewards game described herein. Also, although certain exemplary embodiments have been described in relation to random rewards, it will be appreciated that the present invention is not so limited. For example, certain exemplary embodiments described herein may be used to provide bonus rewards according to any bonusing scheme (including, for example, mystery), simply by using coin-out events as triggers rather than coin-in events.

Also, the exemplary features, aspects, and advantages described herein may be combined in yet further ways to achieve further embodiments.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. In a gaming network comprising a plurality of gaming devices, a method of providing a bonus reward to a patron using a gaming device connected to said gaming network, the method comprising:
generating a random number for win determination;
initializing a coin-out counter accessible by the gaming device being used by the patron;
generating a random win amount for the patron;
detecting whether a coin-out event has occurred on the gaming device;
when a coin-out event is detected, incrementing the coin-out counter; and
when the coin-out counter is greater than or equal to the random number for win determination, awarding the random win amount to the patron.

2. The method of claim 1, further comprising displaying the random win amount to at least the patron via a display of the gaming device.

3. The method of claim 1, wherein the coin-out counter is incremented by a payout amount associated with the coin-out event.

4. The method of claim 1, wherein the coin-out counter is incremented sequentially.

5. The method of claim 1, further comprising after a random win amount is awarded to the patron, generating a new random number for win determination and reinitializing the coin-out counter.

6. The method of claim 1, further comprising after a random win amount is awarded to the patron, displaying an indication of the award on a display external to the gaming device.

7. The method of claim 1, wherein the gaming device is a gaming machine.

8. The method of claim 1, wherein the gaming device is a table game.

9. The method of claim 1, further comprising funding the bonus reward via promotional credits provided to the patron.

10. The method of claim 1, wherein the random win amount is generated in dependence on a status of the patron, the status being determined by a gaming proprietor.

11. The method of claim 1, further comprising funding the bonus reward via a patron contribution.

12. A method of providing a bonus reward to a patron using a gaming device, the method comprising:
generating a random number for win determination;
initializing a coin-out counter accessible by the gaming device being used by the patron;
for each wager made using the gaming device generating a random win amount for the patron and displaying the random win amount to the patron;
detecting whether a coin-out event has occurred on the gaming device;
when a coin-out event is detected, incrementing the coin-out counter, and
when the coin-out counter is greater than or equal to the random number for win determination:
awarding the random win amount to the patron,
generating a new random number for win determination, and
reinitializing the coin-out counter.

13. A gaming device configured to provide a bonus reward to a qualified patron on a bonus rewards link, comprising:
a coin-out monitor configured to detect a coin-out event of the gaming device and to increment a coin-out counter based on the detected coin-out event;
a processor configured to award a random win amount generated by a random number generator to the patron when the coin-out counter is greater than or equal to a random number for win determination generated by the random number generator.

14. The gaming device claim 13, further comprising a display for displaying the random win amount to at least the patron.

15. The gaming device claim 13, wherein the random number generator is further configured to generate a new random number for win determination after a random win amount is awarded to the patron, and
wherein the processor is configured to reset the coin-out counter after a random win amount is awarded to the patron.

16. The gaming device of claim 13, wherein the gaming device is a gaming machine.

17. The gaming device of claim 13, wherein the gaming device is a table game.

18. The gaming device of claim 13, further comprising an in-machine meter configured to fund the bonus reward via promotional credits provided to the patron.

19. The gaming device of claim 13, wherein the random win amount is generated in dependence on a status of the patron, the status being determined by a gaming proprietor.

20. The gaming device of claim 13, further comprising an in-machine meter configured to fund the bonus reward via a patron contribution.

21. The gaming device of claim 13, wherein the random number generator is further configured to generate a new random win amount each time the patron initiates a wager using the gaming device.

22. A gaming device configured to provide a bonus reward to a patron, comprising:
a random number generator configured to generate a random win amount and a random number for win determination;
a coin-out monitor configured to detect a coin-out event of the gaming device;
a coin-out counter configured to be incremented based on a detected coin-out event; and
a processor configured to award the random win amount generated by the random number generator to the patron when the coin-out counter is greater than or equal to the random number for win determination generated by the random number generator.

23. The gaming device of claim 22, wherein the random number generator is further configured to generate a new random win amount each time the patron initiates a wager using the gaming device.

24. The gaming device of claim 22, further comprising a display configured to display to the patron the random win amount.
